(19) United States
(12) Patent Application Publication
(10) Pub. No.: US 2013/0287957 A1
(43) Pub. Date: Oct. 31, 2013

(54) ELECTROLESS PLATING DEVICE AND ELECTROLESS PLATING METHOD

(71) Applicants: Young Ku LYU, Suwon (KR); Jung Wook Seo, Suwon (KR); Dong Hoon Kim, Suwon (KR)

(72) Inventors: Young Ku LYU, Suwon (KR); Jung Wook Seo, Suwon (KR); Dong Hoon Kim, Suwon (KR)

(73) Assignee: SAMSUNG ELECTRO-MECHANICS CO., LTD.

(21) Appl. No.: 13/550,382

(22) Filed: Jul. 16, 2012

(30) Foreign Application Priority Data
Apr. 26, 2012 (KR) 10-2012-0043982

(51) Int. Cl. B05C 3/04; B05D 1/18

(52) U.S. Cl. 427/337; 118/610

(57) ABSTRACT

There is provided an electroless plating device including: a plating bath having a plating solution contained therein; a circulation unit connected to the plating bath and circulating the plating solution contained in the plating bath; an additive supply unit mounted on the circulation unit and supplying an additive for extracting carbonate included in the plating solution; and a filter unit mounted on the circulation unit and filtering the extracted carbonate through a reaction with the additive.

### CROSS-REFERENCE TO RELATED APPLICATIONS

This application claims the priority of Korean Patent Application No. 10-2012-0043982 filed on Apr. 26, 2012, in the Korean Intellectual Property Office, the disclosure of which is incorporated herein by reference.

### BACKGROUND OF THE INVENTION

1. Field of the Invention

The present invention relates to an electroless plating device and an electroless plating method, and more particularly, to an electroless plating device and an electroless plating method capable of extending a plating solution supplementing period.

2. Description of the Related Art

Electroless plating is a method of surface treating an object by a reduction reaction of metal ions. In electroless plating, the continuous reduction reaction of the metal ions changes the activity of a plating solution.

Therefore, in order to maintain a uniform plating quality, the plating solution needs to be replaced at regular intervals or continuously supplemented with a predetermined plating solution, such that an increase in specific gravity of the plating solution needs to be inhibited.

Here, in the former case, wastage of the plating solution maybe significant, and a time required to prepare for a plating process maybe lengthy. On the contrary, in the latter case, the plating process may not be required to be discontinued for the replacement of the plating solution, and wastage of the plating solution may be reduced.

However, since the latter case requires a regular amount of the plating solution to be continuously discarded, as in the former case, it may be difficult to solve problems such as environmental water pollution due to the plating solution and increases in plating costs.

Meanwhile, an example of the related art controlling of a plating solution includes patent document 1 below. However, in patent document 1, since an organic compound included in a plating solution is oxidatively decomposed, metal ions increasing the specific gravity of the plating solution may not effectively be removed.

### RELATED ART DOCUMENT

(Patent Document 1) Japanese Patent Laid-Open Publication No. 2006-249525 A

### SUMMARY OF THE INVENTION

An aspect of the present invention provides an electroless plating device and an electroless plating method capable of extending a period of use of a plating solution.

According to an aspect of the present invention, there is provided an electroless plating device including: a plating bath having a plating solution contained therein; a circulation unit connected to the plating bath and circulating the plating solution contained in the plating bath; an additive supply unit mounted on the circulation unit and supplying an additive for extracting carbonate included in the plating solution; and a filter unit mounted on the circulation unit and filtering the extracted carbonate through a reaction with the additive.

The additive may be a salt including calcium (Ca).

The additive may be calcium hydroxide (Ca(OH)₂).

The circulation unit may include a circulation pipe connected to the plating bath, and a pump circulating the plating solution.

The filter unit may include a filter member.

The filter unit may further include a plating solution blocking valve disposed between the plating bath and the filter member, and a drainage valve disposed between the plating solution blocking valve and the filter member, and the carbonate filtered by the filter member maybe removed in a reverse washing scheme.

The electroless plating device may further include a cooling unit mounted on the circulation unit and cooling the plating solution circulated through the circulation unit.

The electroless plating device may further include a heating unit mounted on the circulation unit and heating the plating solution circulated through the circulation unit.

The cooling unit may maintain the plating solution at a temperature of 10° C. or less.

The filter unit may include a filter tank in which an extracted material is precipitated, and a discharge valve mounted on the filter tank and discharging the precipitated material to the outside.

According to another aspect of the present invention, there is provided an electroless plating method, the method including: circulating a plating solution in a plating bath to the outside; adding an additive for extracting carbonate to the circulated plating solution; and filtering the extracted carbonate through a reaction with the additive.

The additive may be a salt including calcium (Ca).

The additive may be calcium hydroxide (Ca(OH)₂).

The method may further include cooling the plating solution circulated from the plating bath to the outside.

The method may further include heating the plating solution circulated from the outside to the plating bath.

The plating solution may be cooled so as to be maintained at a temperature of 10° C. or less.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates the configuration of an electroless plating device according to an embodiment of the present invention;

FIG. 2 is a view showing an example of a filter unit illustrated in FIG. 1;

FIG. 3 is a view showing another example of the filter unit illustrated in FIG. 1;

FIG. 4 illustrates the configuration of an electroless plating device according to another embodiment of the present invention;

FIG. 5 is a view showing an example of a cooling unit illustrated in FIG. 4; and

FIG. 6 is a graph showing solubility of sodium sulfate according to temperature.

### DETAILED DESCRIPTION OF THE EMBODIMENTS

In electroless plating, sodium hydroxide (NaOH) maybe continuously injected for stability of a plating solution and maintenance of a pH level thereof.

In addition, in electroless copper plating, copper sulfate (CuSO₄) may be continuously injected in order to allow copper plating to be uniformly performed (that is, in order to supplement copper ions).

Here, sodium hydroxide may be reacted with carbon dioxide in the air to thereby produce carbonate (CO₃²⁻) in the plating solution. A sulfate ion (SO₄) extracted from copper sulfate and a sodium ion (Na⁺) extracted from sodium hydroxide may produce sodium sulfate (Na₂SO₄) to increase a specific gravity of the plating solution.

An increase in the specific gravity of the plating solution may reduce a period of use of the plating solution to thereby deteriorate plating efficiency.

In order to solve the problem as described above, the present invention may provide a device physically and chemically removing carbonate and sodium sulfate and increasing the specific gravity of the plating solution and a method thereof.

That is, in the present invention, a salt including calcium (Ca) may be injected into the plating solution to extract the carbonate therefrom, and the plating solution may be temperature-controlled to extract sodium sulfate. In addition, an extracted material maybe removed from the plating solution using a filter and the like.

Therefore, the increase in the specific gravity of the plating solution due to the carbonate and the sodium sulfate maybe effectively inhibited to extend the period of use of the plating solution.

Hereinafter, embodiments of the present invention will be described in detail with reference to the accompanying drawings.

In describing the present invention below, terms indicating components of the present invention are named in consideration of functions thereof. Therefore, the terms should not be understood as limiting technical components of the present invention in any manner.

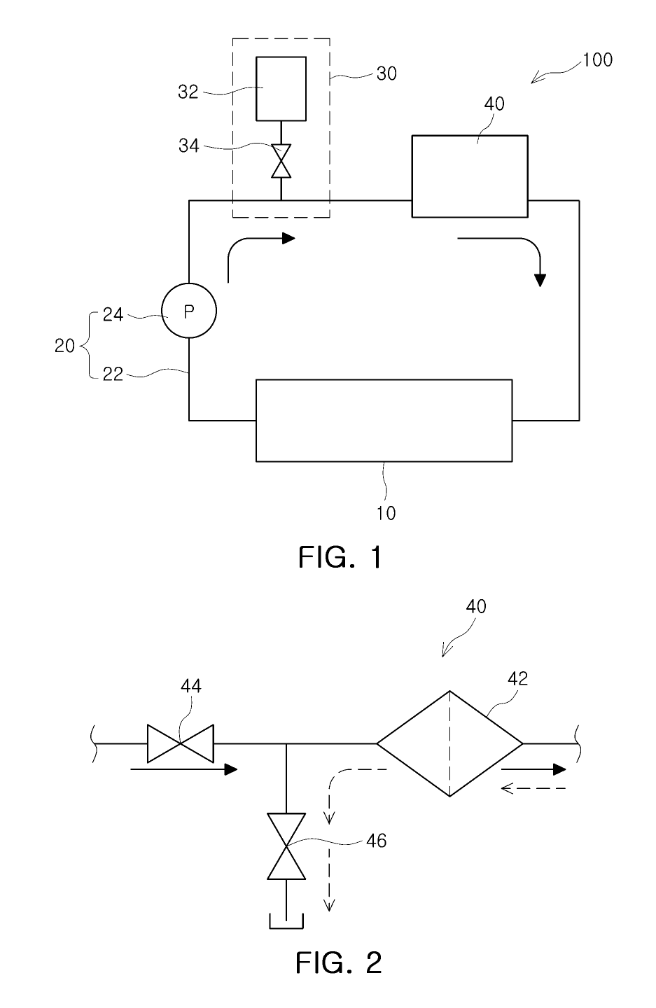

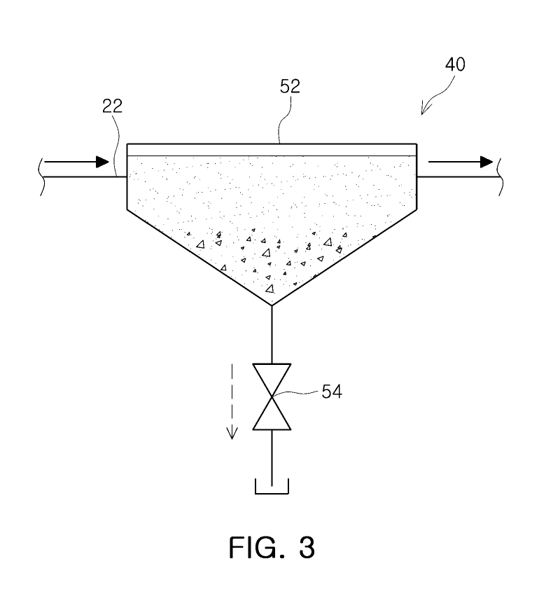

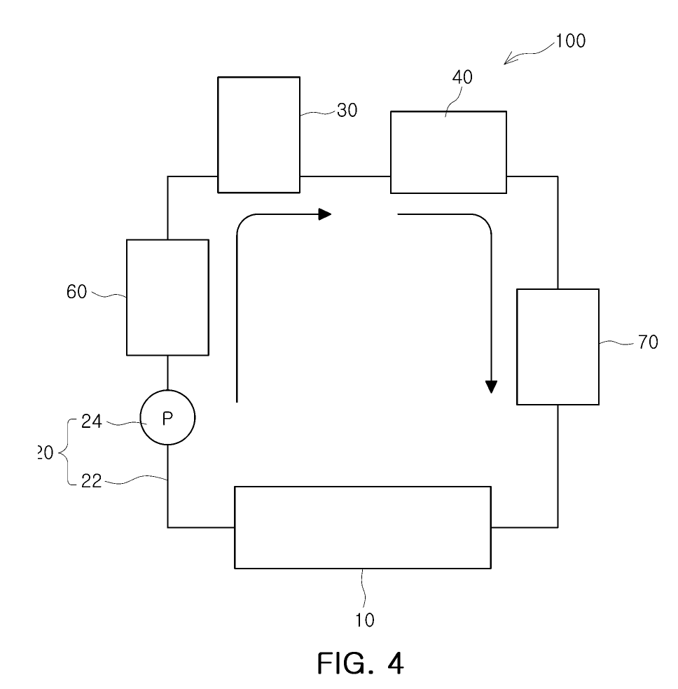

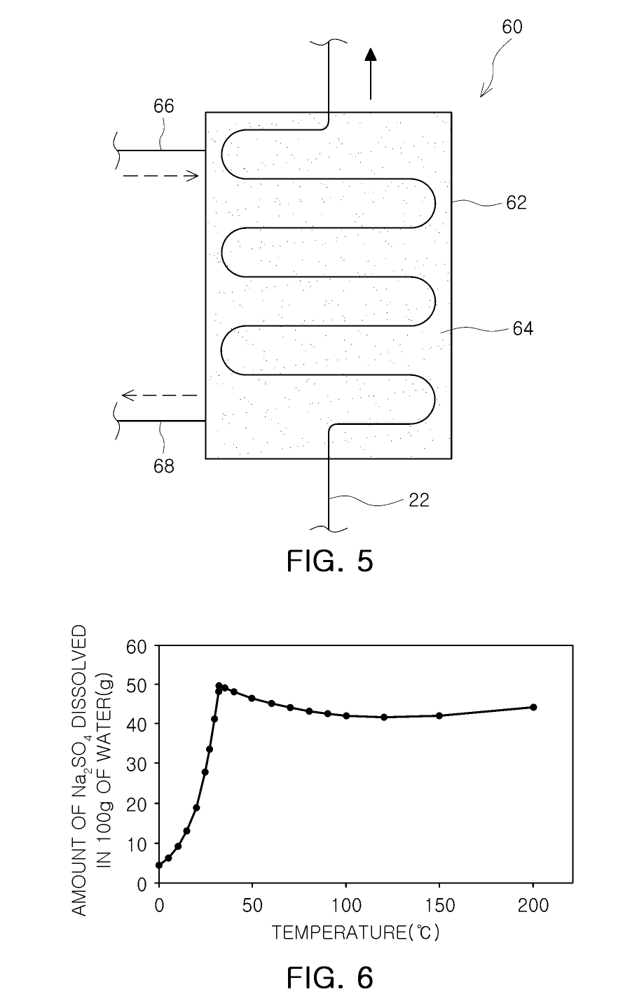

FIG. 1 illustrates the configuration of an electroless plating device according to an embodiment of the present invention; FIG. 2 is a view showing an example of a filter unit illustrated in FIG. 1; FIG. 3 is a view showing another example of the filter unit illustrated in FIG. 1; FIG. 4 illustrates the configuration of an electroless plating device according to another embodiment of the present invention; FIG. 5 is a view showing an example of a cooling unit illustrated in FIG. 4; and FIG. 6 is a graph showing solubility of sodium sulfate according to temperature.

An electroless plating device 100 according to an embodiment of the present invention may include a plating bath 10, a circulation unit 20, an additive supply unit 30, and a filter unit 40.

The plating bath 10 may receive a plating solution required for electroless plating. To this end, the plating bath 10 may have a vessel shape of which one surface is opened. Here, a size and a shape of the plating bath 10 may differ according to a size and a shape of an object to be plated. Therefore, the size and the shape of the plating bath 10 may be arbitrarily modified.

Meanwhile, the plating solution used in the electroless plating of the present invention may include copper sulfate (CuSO₄). However, a material included in the plating solution is not limited to copper sulfate. Therefore, other metal compounds besides copper sulfate may be included in the plating solution.

The circulation unit 20 may be connected to the plating bath 10. The circulation unit 20 may circulate the plating solution in the plating bath 10 to the outside of the plating bath 10. That is, the circulation unit 20 may discharge the plating solution in the plating bath 10 to the outside, and the discharged plating solution may be reintroduced to the plating bath 10. To this end, the circulation unit 20 may include a circulation pipe 22 and a pump 24.

The circulation pipe 22 may be connected to each of surfaces of the plating bath 10 facing each other. For example, one end of the circulation pipe 22 may be connected to one side of the plating bath 10, and the other end thereof may be connected to the other side of the plating bath 10.

The pump 24 may be mounted on the circulation pipe 22 or the plating bath 10. The pump 24 may generate a predetermined pressure to thereby allow the plating solution in the circulation pipe 22 to flow in one direction (forward direction driving). A driving speed and a driving period of the pump 24 may be changed according to a volume of the plating solution contained in the plating bath 10, and a plating period.

For example, in the case in which the plating period is short, the driving speed of the pump 24 may increase or the driving period of the pump 24 may decrease. In the case in which the plating period is long, the driving speed of the pump 24 may decrease or the driving period of the pump 24 may increase. Meanwhile, the pump 24 may be driven so that circulation of the plating solution is performed in an opposite direction (reverse direction driving), as necessary.

The circulation unit 20 configured as described above may continuously circulate the plating solution in the plating bath 10 through the circulation pipe 22 and the pump 24 (see arrows in FIGS. 1 and 2), and suppress sedimentation or an accumulation of materials increasing a specific gravity of the plating solution in the plating bath 10.

The additive supply unit 30 may be connected to the circulation pipe 22. The additive supply unit 30 may inject a predetermined material into the plating solution to thereby extract the materials increasing the specific gravity of the plating solution. For example, the additive supply unit 30 may inject a salt including calcium (Ca) or calcium hydroxide (Ca(OH)₂) into the plating solution to thereby extract the carbonate included in the plating solution.

Hereinafter, a detailed description thereof will be provided below.

In general, the plating solution may react with carbon dioxide in the air to produce the carbonate (H₂CO₃) (see reaction formula 1 below). However, since the carbonate may increase the specific gravity of the plating solution, it needs to be removed.

CO₂+H₂0→H₂CO₃ (Reaction Formula 1)

Here, in the case in which calcium hydroxide is added to the plating solution, a chemical reaction corresponding to the following reaction formula 2 may be generated.

H₂CO₃+Ca(OH)₂→CaCO₃+2H₂O (Reaction Formula 2)

That is, the carbonate (H₂CO₃) may react with calcium hydroxide (Ca(OH)₂) to extract calcium carbonate (CaCO₃) with water (H₂O).

Therefore, in the case in which the extracted calcium carbonate is removed by an appropriate method, the specific gravity of the plating solution may be decreased.

In addition, a hydroxide ion (OH⁻) is produced through the chemical reaction, such that the plating solution may be stabilized and a pH level thereof may be maintained.

The additive supply unit 30 may include an additive storage tank 32 and a supply valve 34.

The additive storage tank 32 may store an additive (for example, calcium hydroxide), and be connected to the circulation pipe 22.

The supply valve 34 may be mounted on the additive storage tank 32. More specifically, the supply valve 34 may be disposed between the additive storage tank 32 and the circulation pipe 22 to control an amount of an additive added to the plating solution. For example, in the case in which an amount of carbonate in the plating solution is higher than a reference value, the supply valve 34 may be opened, and in the case in which an amount of carbonate in the plating solution is lower than the reference value, it may be closed. To this end, the supply valve 34 may be connected to a separate control unit. Here, the control unit may include a detecting sensor detecting an amount of carbonate.

The filter unit 40 may be mounted on the circulation pipe 22, and may filter or remove the materials extracted by the reaction formula 2. To this end, the filter unit 40 may include a filtration means such as a filter, or the like. One example and another example of the filter unit 40 will be described with reference to FIGS. 2 and 3.

One example of the filter unit 40 will be described with reference to FIG. 2.

The filter unit 40 may include a filter member 42, a plating solution blocking valve 44, and a drainage valve 46.

The filter member 42 may be mounted on the circulation pipe 22. The filter member 42 may be disposed in a cross-sectional direction of the circulation pipe 22 to filter calcium carbonate (CaCO₃) included in the plating solution. To this end, the filter member 42 may have a net shape in which it has a plurality of pores formed therein. However, the filter member 42 is not limited to having the net shape, but may have other shapes. In addition, although a material filtered by the filter member 42 in the present embodiment is described as calcium carbonate, other materials (for example, foreign objects or plating residue) may be filtered as needed.

The plating solution blocking valve 44 may be mounted on the circulation pipe 22. More specifically, the plating solution blocking valve 44 may be mounted in the rear (based on the circulation direction of the plating solution) of the filter member 42 in the circulation pipe 22. The plating solution blocking valve 44 disposed as described above may be closed as needed to thereby block the plating solution from being supplied to the filter member 42.

The drainage valve 46 maybe mounted on the circulation pipe 22. More specifically, the drainage valve 46 may be disposed between the plating solution blocking valve 44 and the filter member 42. The drainage valve 46 disposed as described above may discharge the plating solution in the circulation pipe 22 to the outside.

Meanwhile, in the case in which the plating solution is circulated through the circulation pipe 22 and the additive is injected thereinto, calcium carbonate which is the object material to be removed may be filtered by the filter member 42. Here, in the case in which a small amount of calcium carbonate is attached to the filter member 42, it may not affect the circulation of the plating solution; however, in the case in which a significant amount of calcium carbonate is attached to the filter member 42, it may affect the circulation of the plating solution.

In order to solve this problem, the filter unit 40 according to the embodiment of the present invention is provided, and a washing of the filter member 42 may allow the plating solution to be smoothly circulated.

The washing process (which refers to a reverse washing process in the appended claims) of the filter member 42 may be sequentially performed during a pause in driving of the pump 24, blocking of the plating solution blocking valve 44, reverse direction driving of the pump 24, reverse circulation of the plating solution, or an opening of the drainage valve 46.

The washing process performed in such a order may separate an extracted material (for example, calcium carbonate) and foreign objects attached to the filter member 42, and discharge the materials to the drainage valve 46 (see dotted lines illustrated in FIG. 2). That is, since the plating solution in the washing process may flow in a direction from an opposite side of the filter member 42 to the drainage valve 46, the extracted material may be separated from the filter member 42 and the extracted material may be discharged to the drainage valve 46. Therefore, according to the washing process, the filter member 42 maybe reusable, and the extracted material may be easily removed therefrom.

In the case in which the washing process is completed, the drainage valve 46 may be closed and the plating solution blocking valve 44 may be opened. In addition, the pump 24 may be driven so that the plating solution may flow in an original circulation direction (forward direction driving).

For reference, a washing point of the filter member 42 may be set through a circulation speed change of the plating solution or a load change of the pump 24 (or a change in current consumption). For example, the process of washing the filter member 42 may be performed at a point in time at which the circulation speed of the plating solution falls below a preset speed or the load acting on the pump 24 increases. That is, in the point, the extracted materials or the foreign objects are attached to the filter member 42 in a relatively large amount to disturb the circulation of the plating solution, such that the washing process may be performed at this point.

Another example of the filter unit 40 will be described with reference to FIG. 3.

The filter unit 40 having other shape may include a filter tank 52 and a discharge valve 54.

The filter tank 52 may have a shape in which a cross-sectional area thereof is decreased in a downward direction. However, the shape of the filter tank 52 may be varied as necessary.

The discharge valve 54 may be mounted at the bottom of the filter tank 52. Due to the mounting position of the discharge valve 54, the extracted material or the foreign objects collected in a lower portion of the filter tank 52 may be easily discharged to the outside.

For reference, the circulation pipe 22 may be mounted at the upper portion of the filter tank 52 or be mounted at a position relatively higher than that of the discharge valve 54 in the filter tank 52.

The filter unit 40 configured as described above may easily remove the extracted material or the foreign objects having a relatively high specific gravity in the plating solution without a separate operation. For reference, the filter tank 52 may have a transparent window mounted thereon so that a sedimentation amount of the extracted material or the foreign objects may be easily appreciated.

Hereinafter, a plating method using the electroless plating device 100 configured as described above will be described.

An electroless plating method according to the present embodiment may include 1) circulating a plating solution, 2) injecting an additive, and 3) removing an extracted material. In addition, the electroless plating method according to the present embodiment may further include plating a plating object.

### 1) Circulating of Plating Solution

The circulating of the plating solution may be performed over the entire plating process or may be partially performed during the plating process.

The circulating of the plating solution may be performed in a scheme in which the plating solution contained in the plating bath 10 is discharged to the outside and resupplied to the plating bath 10, and may be performed using the pump 24. In addition, the circulation speed of the plating solution may be determined within a range not affecting plating quality.

### 2) Injecting of Additive

The injecting of the additive may be performed outside the plating bath 10. For example, the injecting of the additive may be performed in the circulation pipe 22 circulating the plating solution. However, the additive may be injected into the plating bath 10 as needed.

The additive may be a material increasing the specific gravity of the plating solution or a material reacting with a metal ion. For example, the additive may be a salt including calcium (Ca). The additive in an electroless copper plating may be calcium hydroxide (Ca(OH)₂). Here, the salt including calcium or calcium hydroxide may be reacted with the carbonate of the plating solution to thereby extract calcium carbonate (see reaction formula 2).

### 3) Removing of Extracted Material

The removing of the extracted material may be performed through a process such as filtration, or the like. For example, the filter member for removing the extracted material may be mounted on the plating bath 10 or the circulation pipe 22. In addition, the extracted material attached to the filter member maybe removed from the plating solution by the reverse washing process as described above or other methods.

Since the above-described electroless plating method may remove the material increasing the specific gravity of the plating solution, the period of use of the plating solution may be extended. Therefore, the electroless plating method according to the present embodiment may significantly decrease wastage of the plating solution and reduce a pollution problem due to the plating solution.

Hereinafter, an electroless plating device according to another embodiment of the present invention will be described with reference to FIGS. 4 to 6. For reference, in the present embodiment, the same reference numerals will be used to designate the same components as those described in the previous embodiment. A detailed description of the same components will be omitted.

The electroless plating device 100 according to the present embodiment may further include a cooling unit 60 and a heating unit 70.

The cooling unit 60 may cool the plating solution discharged from the plating bath 10. To this end, the cooling unit 60 may be disposed between the plating bath 10 and the additive supply unit 30.

The cooling unit 60 may include a refrigerant tank 62 storing a refrigerant 64 as illustrated in FIG. 5. Here, the refrigerant tank 62 may include pipes 66 and 68 for circulating the refrigerant 64, and have at least a portion of the circulation pipe 22 received therein. The circulation pipe 22 disposed in the refrigerant tank 62 may have a zigzag shape as illustrated in FIG. 5.

The cooling unit 60 configured as described above may extract some materials (for example, sodium sulfate (Na₂SO₄)) included in the plating solution by lowering a temperature of the plating solution.

In general, sodium hydroxide (NaOH) maybe injected for stability, pH level control, and a plating reaction of the plating solution, and the like. Here, a sodium ion (Na⁺) of sodium hydroxide may be reacted with a sulfate (SO₄⁻) of copper sulfate (CuSO₄) to form sodium sulfate. However, since sodium sulfate formed by the reaction increases the specific gravity of the plating solution, it needs to be removed.

Meanwhile, sodium sulfate included in the plating solution may have solubility of 30 g/100 g water at a temperature of 30 degrees or higher; however, the solubility (10 g/100 g water) is significantly decreased at a temperature of 10° C. or less (see FIG. 6).

In order to solve this problem, the present embodiment may cool the plating solution below 10° C. to thereby extract sodium sulfate therefrom. However, this is only an example and other materials may be extracted through the cooling of the plating solution. The material extracted by the cooling unit 60 may be removed through the filter unit 40, along with calcium carbonate. For reference, in the present embodiment, the cooling temperature of the plating solution is exemplified as 10° C.; however, it may be controlled to be 4° C. or less as needed.

The heating unit 70 may heat the plating solution flowing into the plating bath 10. To this end, the heating unit 70 may be disposed between the filter unit 40 and the plating bath 10. The heating unit 70 configured as described above may increase the temperature of the plating solution over 30° C. so as to increase the solubility of the sodium sulfate.

The plating method using the electroless plating device configured as described above may be performed in the order of the cooling of the plating solution, the injecting of the additive, the removing of the extracted material, and the heating of the plating solution.

The cooling of the plating solution may be a process of cooling the plating solution at a temperature of 10° C. or less or 4° C. or less. In the case of cooling the plating solution, sodium sulfate, a material increasing the specific gravity of the plating solution, may be extracted. That is, since the solubility of sodium sulfate in water is significantly decreased at a low temperature of 10° C. or less, sodium sulfate may be easily extracted through the cooling of the plating solution.

The injecting of the additive may be a process for extracting other materials increasing the specific gravity of the plating solution. For example, the additive may be a salt including calcium, which may extract calcium carbonate.

The removing of the extracted material maybe a process of removing sodium sulfate and calcium carbonate produced in the above process. The removing of these materials may be performed using the filter member or using a separate device.

Meanwhile, since the specific gravity of the plating solution may be significantly decreased in the case of removing the materials from the plating solution, the period of use of the plating solution may be extended. In addition, since the plating solution is not required to be separately injected or to be replaced, a plating time may be decreased to thereby decrease plating costs.

The heating of the plating solution may be a process of heating the plating solution at a temperature of 30° C. or higher. As described above, in the case in which the temperature of the plating solution increases at a temperature of 30° C. or higher, the plating reaction due to the metal ion may be actively performed.

Meanwhile, although the plating solution is cooled before the injecting of the additive in the above-described embodiment, an order of the cooling of the plating solution and the injecting of the additive may be changed as needed. For example, in another embodiment, after the injecting of the additive may be firstly performed, the cooling of the plating solution may be performed.

As set forth above, ions generated in an electroless plating process may be effectively removed, which may extend a period of use of a plating solution.

While the present invention has been shown and described in connection with the embodiments, it will be apparent to those skilled in the art that modifications and variations can be made without departing from the spirit and scope of the invention as defined by the appended claims.

What is claimed is:

1. An electroless plating device comprising:
a plating bath having a plating solution contained therein;
a circulation unit connected to the plating bath and circulating the plating solution contained in the plating bath;
an additive supply unit mounted on the circulation unit and supplying an additive for extracting carbonate included in the plating solution; and
a filter unit mounted on the circulation unit and filtering the extracted carbonate through a reaction with the additive.

2. The electroless plating device of claim 1, wherein the additive is a salt including calcium (Ca).

3. The electroless plating device of claim 2, wherein the additive is calcium hydroxide (Ca(OH)₂).

4. The electroless plating device of claim 1, wherein the circulation unit includes:
a circulation pipe connected to the plating bath; and
a pump circulating the plating solution.

5. The electroless plating device of claim 1, wherein the filter unit includes a filter member.

6. The electroless plating device of claim 5, wherein the filter unit further includes:
a plating solution blocking valve disposed between the plating bath and the filter member; and
a drainage valve disposed between the plating solution blocking valve and the filter member, and
the carbonate filtered by the filter member is removed in a reverse washing scheme.

7. The electroless plating device of claim 1, further comprising a cooling unit mounted on the circulation unit and cooling the plating solution circulated through the circulation unit.

8. The electroless plating device of claim 7, further comprising a heating unit mounted on the circulation unit and heating the plating solution circulated through the circulation unit.

9. The electroless plating device of claim 7, wherein the cooling unit maintains the plating solution at a temperature of 10° C. or less.

10. The electroless plating device of claim 7, wherein the filter unit includes:
a filter tank in which an extracted material is precipitated; and
a discharge valve mounted on the filter tank and discharging the precipitated material to the outside.

11. An electroless plating method, the method comprising:
circulating a plating solution in a plating bath to the outside;
adding an additive for extracting carbonate to the circulated plating solution; and
filtering the extracted carbonate through a reaction with the additive.

12. The method of claim 11, wherein the additive is a salt including calcium (Ca).

13. The method of claim 12, wherein the additive is calcium hydroxide (Ca(OH)₂).

14. The method of claim 11, further comprising cooling the plating solution circulated from the plating bath to the outside.

15. The method of claim 14, further comprising heating the plating solution circulated from the outside to the plating bath.

16. The method of claim 14, wherein the plating solution is cooled so as to be maintained at a temperature of 10° C. or less.
